(19) United States
(12) Patent Application Publication
(10) Pub. No.: US 2023/0105897 A1
(43) Pub. Date: Apr. 6, 2023

(54) Methods and Systems for Blazed Mirror Oblique Plane Microscopy (OPM) Imaging of Oblique Planes

(71) Applicant: Salk Institute for Biological Studies, La Jolla, CA (US)

(72) Inventors: Hu Cang, San Diego, CA (US); Qing Ye, Tianjin (CN)

(21) Appl. No.: 17/908,850

(22) PCT Filed: Mar. 5, 2021
(86) PCT No.: PCT/US2021/021126

§ 371 Date: Sep. 1, 2022

Related U.S. Application Data
(60) Provisional application No. 62/985,677, filed on Mar. 5, 2020.
(60) Provisional application No. 63/040,769, filed on Jun. 18, 2020.

(51) Int. Cl. G02B 5/09; G02B 21/00; G02B 21/36

(52) U.S. Cl. CPC G02B 5/09; G02B 21/0048; G02B 21/367; G02B 21/0032

(57) ABSTRACT

Some embodiments of the present disclosure disclose methods and systems for imaging oblique planes of a sample using oblique plane microscopes employing blazed minors. Such a system can include a first optical sub-assembly, a blazed mirror and a second optical sub-assembly, wherein the first optical sub-assembly is configured to receive light beams from an oblique plane of a sample and produce intermediate light beams that are reflected by the blazed mirror to the second optical sub-assembly so that the latter can produce an image of the oblique plane of the sample.

### CROSS REFERENCE TO RELATED APPLICATIONS

The present application claims priority to and the benefit of U.S. Provisional Patent Application No. 62/985,677, filed Mar. 5, 2020, titled “Blazed Mirror Oblique Plane Imaging,” and U.S. Provisional Patent Application No. 63/040,769, filed Jun. 18, 2020, titled the same, both of which are hereby incorporated by reference in their entirety as though fully set forth below and for all applicable purposes.

### FIELD OF THE DISCLOSURE

The present disclosure generally relates to three-dimensional (3D) imaging and microscopy, and more specifically, imaging of oblique planes of a sample using oblique plane microscopes employing blazed mirrors.

### Introduction

A camera generates a 2-dimensional (2D) image of objects located on a plane that is perpendicular to its optical axis. Images of objects that are located on a plane that is not perpendicular to the optical axis, i.e., an oblique image plane, can be captured using a light-sheet microscope, where two or more objective lenses are used and one of them generates an illuminating plane (i.e., light-sheet) that is placed normal to the imaging plane. A three-dimensional (3D) volumetric image of an object can then be generated by scanning the object through oblique image planes to capture a series of oblique images of the oblique planes, and combining the series of oblique images to form the 3D volumetric image.

### SUMMARY

In some embodiments, an oblique plane microscopy (OPM) system comprises a first optical sub-assembly having a first numerical aperture and an objective lens, a blazed mirror and a second optical sub-assembly having a second numerical aperture. In some instances, the first optical sub-assembly is configured to receive light beams from an oblique plane of a sample that is at an oblique angle to a first optical axis of the first optical sub-assembly; and produce intermediate light beams configured to form an intermediate image of the oblique plane at an intermediate image plane. In some instances, the blazed mirror can be arranged at the intermediate image plane and configured to receive the intermediate light beams from the first optical sub-assembly and reflect said intermediate light beams to the second optical sub-assembly so that an axis of a cone of the reflected intermediate light beams at least substantially aligns with a second optical axis of the second optical sub-assembly. Further, an angle between the first optical axis and the second optical axis at the intermediate image plane may relate to the oblique angle. In some instances, the second optical sub-assembly may be configured to receive the reflected intermediate light beams and produce an image of the oblique plane of the sample.

In some embodiments, an oblique plane microscopy (OPM) method comprises receiving, at a first optical sub-assembly of an OPM system having a first numerical aperture and an objective lens, light beams from an oblique plane of a sample that is at an oblique angle to a first optical axis of the first optical sub-assembly. Further, the method comprises producing, by the first optical sub-assembly, intermediate light beams configured to form an intermediate image of the oblique plane at an intermediate image plane. The method also comprises receiving, at a blazed mirror arranged at the intermediate image plane, the intermediate light beams from the first optical sub-assembly and reflect said intermediate light beams to a second optical sub-assembly of the OPM system so that an axis of a cone of the reflected intermediate light beams at least substantially aligns with a second optical axis of the second optical sub-assembly, the second optical sub-assembly having a second numerical aperture. In addition, the method comprises receiving the reflected intermediate light beams and producing an image of the oblique plane of the sample. In some instances, an angle between the first optical axis and the second optical axis at the intermediate image plane may relate to the oblique angle.

In some embodiments, a three-dimensional (3D) imaging method comprises arranging, at a first intermediate image plane and for a first oblique plane of a sample that is at a first oblique angle to a first optical axis of a first optical sub-assembly, a blazed mirror that is configured to receive first intermediate light beams from the first optical sub-assembly and reflect said first intermediate light beams to a second optical sub-assembly so that an axis of a first cone of the reflected first intermediate light beams at least substantially aligns with a second optical axis of the second optical sub-assembly. In some instances, the first optical sub-assembly may be configured to receive first light beams from the first oblique plane and provide the first intermediate light beams to the blazed mirror. Further, in some instances, the second optical sub-assembly may be configured to receive the reflected first intermediate light beams and produce a first image of the first oblique plane. In addition, a first angle between the first optical axis and the second optical axis at the first intermediate image plane may relate to the first oblique angle.

In some embodiments, the 3D imaging method further comprises arranging, at a second intermediate image plane and for a second oblique plane of a sample that is at a second oblique angle to the first optical axis of the first optical sub-assembly, the blazed mirror that is further configured to receive second intermediate light beams from the first optical sub-assembly and reflect said second intermediate light beams to the second optical sub-assembly so that an axis of a second cone of the reflected second intermediate light beams at least substantially aligns with the second optical axis of the second optical sub-assembly. In some instances, the first optical sub-assembly may be configured to receive second light beams from the second oblique plane and provide the second intermediate light beams to the blazed mirror. Further, the second optical sub-assembly may be configured to receive the reflected second intermediate light beams and produce a second image of the second oblique plane. In addition, a second angle between the first optical axis and the second optical axis at the second intermediate image plane relates to the second oblique angle. In some embodiments, the 3D imaging method further comprises combining the first image and the second image to generate a 3D volumetric image of the sample.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 shows an example schematic illustrating an oblique plane microscopy (OPM) system employing a blazed mirror, in accordance with various embodiments.

FIG. 2 is a schematic diagram illustrating reduction or elimination of signal loss by using a blazed mirror in an OPM system, in accordance with various embodiments.

FIG. 3 shows an example computer ray-tracing simulation illustrating oblique plane imaging with an OPM system employing a blazed mirror, in accordance with various embodiments.

FIGS. 4A-4B show example schematics illustrating imaging of multiple oblique planes of a sample for generating a three-dimensional (3D) volumetric image of the sample, in accordance with various embodiments.

FIG. 5 is a flow chart illustrating an OPM method, in accordance with various embodiments.

FIG. 6 is a flow chart illustrating a 3D imaging method, in accordance with various embodiments.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Light-sheet microscopy or selective plane illumination microscopy refers to a fluorescence microscopy technique where fluorescence excitation and detection of a sample occur via separate and orthogonal optical paths. A focused light-sheet can be used to illuminate a selected plane of a sample from the side of the sample along an illumination optical axis that is orthogonal to the detection optical axis (e.g., an optical axis of an imaging camera). An illumination optics may be configured to illuminate a portion or plane of the sample that is located at or around the focal plane of the detection optics, which allows a detection optics (e.g., objective lens) to efficiently collect the signals emitted by the illuminated portion. Because the illumination optical axis and the detection optical axis are separate, i.e., orthogonal to each other, light-sheet microscopy uses (and in some cases, requires) the use of multiple objective lenses, at least one of these multiple objective lenses being used for generating the focused light-sheet and at least another one of these multiple objective lenses being used for imaging the fluorescence signals emitted by the illuminated sample onto an imaging camera.

Oblique plane microscopy (OPM), on the other hand, is a technique that avoids the use of multiple objective lenses, where a single objective lens is used for both illumination and detection/imaging. In OPM, two imaging systems are arranged in series and the single objective lens is used to illuminate an oblique plane of a sample, i.e., generate the illumination plane, that is normal to an imaging plane. An oblique plane of the sample is a plane of the sample that is at an oblique angle with respect to the optical axis of the imaging system that is the first to receive the light emissions emitted by the oblique plane (e.g., the first imaging system of the two imaging systems that is closest to the sample). The first imaging system may then generate an intermediate image of the oblique plane, which subsequently is re-imaged onto the imaging plane of an imaging camera by the second imaging system that is in series with the first imaging system. By varying the angle between the optical axes of the first imaging system and the second imaging system, a series of images of the oblique planes of the sample can be imaged onto the imaging camera, and these series of images may then be combined to generate a three-dimensional (3D) volumetric image of the sample, i.e., the 3D volumetric image of the sample may be reconstructed using the images of the oblique planes captured by the imaging camera. An example of the imaging camera is a charge-coupled device (CCD) camera.

A non-zero angle between the first imaging system and the second imaging system, however, can cause loss of signals or beams emitted by oblique planes, and result in degraded imaging of the oblique planes. Further, a non-zero angle may also limit the applicability of the OPM system for imaging samples. For example, because of the tilt between the first imaging system and the second imaging system, only a portion of the intermediate light beams of the intermediate image may be collected at the second imaging system, resulting in a loss of beams or signals from that oblique images (e.g., and as such the imaging of lower quality oblique images at the imaging camera). In some cases, the first imaging system and/or the second imaging system may be configured to have large numerical apertures (e.g., larger than about 1) to increase the amount of intermediate light beams collected at the second imaging system. For example, oil or solid immersion objective lenses may be used to increase the numerical apertures of the imaging systems, which may result in increased sensitivity to environmental vibrations and decreased working distances, i.e., reduced distances from the front edge of the objective lenses to the oblique planes (e.g., focal point of the beams emitted by the oblique planes). For some applications, however, dry lenses with small numerical aperture and long working distances are desirable, and OPM systems that have large numerical apertures, oil or solid immersed objective lenses and/or short working distances may not be suitable.

The present disclosure discloses methods and systems for blazed mirror OPM imaging of oblique planes of samples. In some embodiments, the OPM system may include a first optical sub-assembly and a second optical sub-assembly with optical axes that are at an angle to each other at the intermediate image plane. In some instances, the intermediate image plane may refer to the plane where the first optical sub-assembly forms an intermediate image of an oblique plane of a sample after the first optical sub-assembly receives lights beams from the oblique plane of the sample (e.g., after the oblique plane is illuminated with an illumination beam). In some instances, the OPM system may also include a blazed mirror that is configured to receive the intermediate light beams from the first optical sub-assembly and reflect at least a portion of the received intermediate light beams to the second optical sub-assembly for imaging into an imaging camera. For example, the blazed mirror can be configured (e.g., including but not limited to shaped, sized, positioned, etc.) to reflect a significantly high amount (e.g., greater than about 90%, about 95%, about 99%, etc.) of the received intermediate image light beams.

Embodiments of the disclosed methods and systems have several benefits. Because the blazed mirror of the disclosed OPM system receives and reflects at least a large proportion of the intermediate light beams, there may be little or no signal loss, leading to higher quality oblique plane images at the imaging camera after the reflected intermediate light beams are received by the second optical sub-assembly and imaged onto the imaging camera (e.g., compared to oblique plane images that would be produced with same OPM system lacking the blazed mirror). Further, because most or all of the intermediate light beams are received and reflected by the blazed mirror, in some embodiments, the first optical sub-assembly and/or the second optical sub-assembly of the disclosed OPM system can have low numerical apertures, and may also have objective lenses that operate without oil or solid immersions and have long working distances. That is, the disclosed OPM system may be used for applications where dry lenses with small numerical apertures and/or long working distances are desirable, or required.

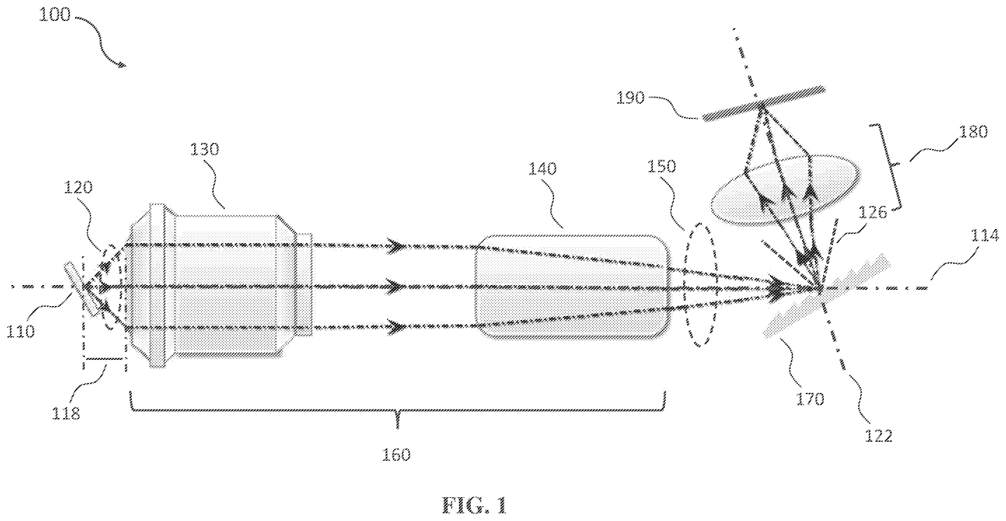

FIG. 1 shows an example schematic illustrating an oblique plane microscopy (OPM) system 100 employing a blazed mirror, in accordance with various embodiments. In some embodiments, the OPM system 100 may be part of a live cell cytometer/imaging system and the oblique plane 110 may be an oblique plane of a sample of live cells that is being investigated with the live cell cytometer. For instance, the live cell cytometer including the OPM system 100 may be used for applications such as but not limited to immune therapy, suspension cell studies, stem cell therapy, spheroid drug screening, etc., and the oblique plane 110 may be an oblique plane of a sample of cells being investigated for the respective applications. In some embodiments, the OPM system 100 may be part of a high-speed 3D deoxyribonucleic acid (DNA) sequencer and the oblique plane 110 may be an oblique plane of a sample of DNA. As discussed in more details below, in some embodiments, the OPM system 100 may be used to produce an oblique image 190 of the oblique plane 110 of a sample (e.g., live cells, DNA, etc.), and a series of oblique images corresponding to multiple oblique planes of the sample may be combined to generate a 3D volumetric image of the sample.

In some embodiments, the OPM system 100 may be part of a light detection and ranging (LIDAR) system or radio detection and ranging (RADAR) system used for depth sensing and the oblique plane 110 may be an oblique plane of an entity that is being investigated with the LIDAR or RADAR. For example, the LIDAR or RADAR system that includes the OPM system 100 may be mounted on a vehicle and may be used for detecting entities that are in the vicinity of the vehicle, such as but not limited to structures, pedestrians, other vehicles, etc. In such cases, the oblique plane 110 may be an oblique plane of the entity that is being detected by the LIDAR or RADAR system. In some instances, as discussed above, the OPM system 100 may be used to produce multiple oblique images 190 of respective multiple oblique planes 110 of the entity, and the multiple oblique images may be combined to generate a 3D volumetric image of the entity (e.g., and as such, facilitate or allow depth sensing of the entity).

In some embodiments, a light source (e.g., a collimated laser source) may be used to illuminate the oblique plane 110 of a sample or entity (hereinafter referred generally as a “sample”) with an incident light beam that is configured to excite the oblique plane 110. In response, the oblique plane 110 of the sample may be excited and emit excitation light beams 120 that are received or collected by the first optical sub-assembly 160. For example, the excitation light beams 120 can be fluorescence light beams emitted by the oblique plane 110. In some instances, the excitation light beams 120 from the oblique plane 110 that are received or collected by the first optical sub-assembly 160 can be light beams that are scattered or reflected by the oblique plane 110. In some embodiments, the term “oblique plane” (e.g., oblique plane 110) may refer to a plane of a sample that is oriented or tilted at an oblique angle with respect to the optical axis 114 of the optical sub-assembly (e.g., the first optical sub-assembly 160) that is configured or positioned to receive the emissions (e.g., excitation light beams 120) emitted by the oblique plane.

In some embodiments, the excitation light beams 120 may be received by the first optical sub-assembly 160 of the OPM system 100. In some instances, the first optical sub-assembly 160 may include one or more objective lenses, i.e., the first optical sub-assembly 160 may include a single objective lens 130 or multiple objective lenses. In some instances, the first optical sub-assembly 160 may further include additional optical components such as but not limited to a tube lens 140. Example of additional optical components include scan lenses, mirrors, etc. As noted above, in some cases, the optical axis 114 of the first optical sub-assembly 160 may be at an oblique angle to the oblique plane 110 of the sample.

In some embodiments, the numerical aperture of the first optical sub-assembly 160 and/or the objective lens 130 can be in the range from about 0.01 to about 1.65, from about 0.025 to about 1.55, from about 0.05 to about 1.5, from about 0.075 to about 1.4, from about 0.1 to about 1.3, from about 0.2 to about 1.2, from about 0.25 to about 1, from about 0.3 to about 0.9, from about 0.35 to about 0.8, from about 0.4 to about 0.7, from about 0.5 to about 0.6, etc., including values and subranges therebetween. In some instances, the listed values of numerical aperture may be those of the objective lens 130 and may also be equal to the upper limit of the numerical aperture values of the first optical sub-assembly 160. In some embodiments, the magnification of the first optical sub-assembly 160 and/or the objective lens 130 can be in the range from about 0.5× to about 150×, from about 1× to about 100×, from about 2× to about 80×, from about 4× to about 60×, from about 8× to about 40×, from about 10× to about 20×, etc., including values and subranges therebetween. In some instances, one or more of the above noted values and subranges of numerical apertures and/or magnifications may be in the absence of an oil or solid immersion objective lens in the first optical sub-assembly 160. For example, the objective lens 130 in the first optical sub-assembly 160 may be operating without an oil or solid immersion.

In some embodiments, the working distance 118 of the first optical sub-assembly 160 and/or the objective lens 130, i.e., the distance from the edge of the first optical sub-assembly 160 and/or the objective lens 130 to the oblique plane 110 (e.g., focal point of the beams emitted by the oblique plane 110), can be in the range from about 0.03 mm to about 50 mm, from about 0.1 mm to about 50 mm, from about 0.5 mm to about 50 mm, from about 1 mm to about 45 mm, from about 5 mm to about 40 mm, from about 10 mm to about 35 mm, from about 15 mm to about 30 mm, from about 20 mm to about 25 mm, etc., including values and subranges therebetween. In some instances, one or more of the above noted values and subranges of working distances may be in the absence of an oil or solid immersion objective lens in the first optical sub-assembly 160. For example, the objective lens 130 in the first optical sub-assembly 160 may be operating without an oil or solid immersion.

In some embodiments, the first optical sub-assembly 160 may receive the excitation light beams 120 emitted by the oblique plane 110 and in response generate intermediate light beams 150 that are configured to form an intermediate image of the oblique plane 110 at the focal plane of the intermediate light beams 150. That is, the first optical sub-assembly 160 may receive the excitation light beams 120 at the objective lens 130, for instance, and direct the excitation light beams 120 via the tube lens 140 (e.g., and additional components of the first optical sub-assembly 160 such as lenses, mirrors, etc., if present) to produce the intermediate light beams 150. In some instances, the generated intermediate light beams 150 may form the intermediate image of the oblique plane 110 at the focal plane, i.e., at the intermediate image plane, of the intermediate light beams 150.

In some embodiments, the OPM system 100 may include a blazed mirror 170 arranged at the intermediate image plane and configured to receive and reflect at least a substantial portion of the intermediate light beams 150 to the second optical sub-assembly 180 of the OPM system 100. In some instances, the second optical sub-assembly 180 may be arranged as part of the OPM system 100 such that the angle, at the intermediate image plane, between the first optical axis 114 of the first optical sub-assembly 160 and the second optical axis 122 of the second optical sub-assembly 180 may correspond to, relate to or be determined or selected based on the oblique angle between the oblique plane 110 and the first optical axis 114 of the first optical sub-assembly 160. That is, the angle between the first optical axis 114 and the second optical axis 122 at the intermediate image plane may be uniquely determined based on the oblique angle of the oblique plane 110 with respect to the first optical axis 114. Further, in some instances, the angle between the first optical axis 114 and the second optical axis 122 may also be determined or selected based on the magnification of the first optical sub-assembly 160 and/or the objective lens 130.

In some embodiments, the second optical sub-assembly 180 may have a numerical aperture that is the same as or different from the numerical aperture of the first optical sub-assembly 160. For example, the numerical aperture of the second optical sub-assembly 180 can be in the range from about 0.01 to about 1.65, from about 0.025 to about 1.55, from about 0.05 to about 1.5, from about 0.075 to about 1.4, from about 0.1 to about 1.3, from about 0.2 to about 1.2, from about 0.25 to about 1, from about 0.3 to about 0.9, from about 0.35 to about 0.8, from about 0.4 to about 0.7, from about 0.5 to about 0.6, etc., including values and subranges therebetween. Further, the magnification of the second optical sub-assembly 180 can be in the range from about 0.5× to about 150×, from about 1× to about 100×, from about 2× to about 80×, from about 4× to about 60×, from about 8× to about 40×, from about 10× to about 20×, etc., including values and subranges therebetween.

In some embodiments, the blazed mirror 170 may be arranged at the intermediate image plane, i.e., at the focal plane of the intermediate light beams 150, to at least substantially overlap the intermediate image plane. That is, the blazed mirror 170 may be positioned at the intermediate image plane at least substantially parallel thereto (e.g., the base or bottom surface of the blazed mirror 170 may be at least substantially parallel to the intermediate image plane). By at least “substantially parallel”, it is to be understood that any lateral distance between the blazed mirror 170 and the intermediate image plane is no greater than about 10 μm, about 5 μm, about 1 μm, including values and subranges therebetween, and any angle between the blazed mirror 170 and the intermediate image plane is no greater than about 10°, about 5°, about 1°, including values and subranges therebetween. In some instances, the effects, on the imaging of the oblique plane 110, of such translational and rotational deviations of the blazed mirror from being parallel (e.g., fully parallel) to the intermediate image plane may depend on the magnification and numerical apertures of the first optical sub-assembly 160 and/or the second optical sub-assembly 180. That is, the sensitivity of the imaging of the oblique plane 110 on such translational and rotational deviations may depend on the magnification and numerical apertures of the first optical sub-assembly 160 and/or the second optical sub-assembly 180. For example, the deviations may have less effect on the quality of the final image of the oblique plane 110 for larger magnification and numerical aperture values, and vice versa).

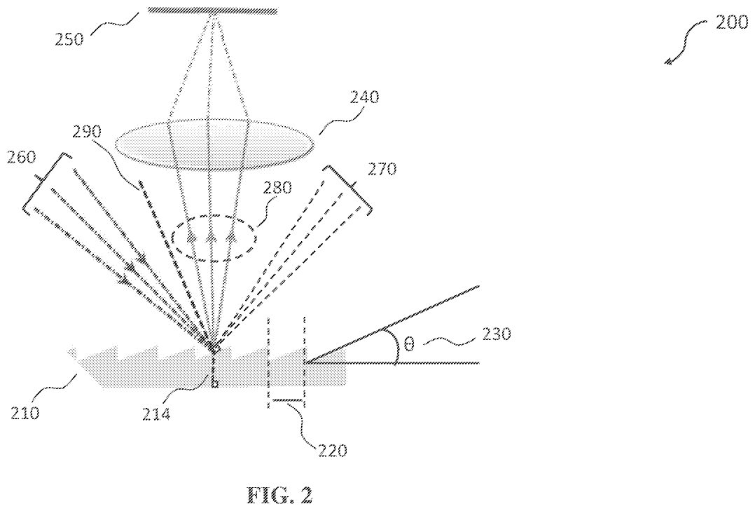

Further, as noted above, the blazed mirror 170 may be configured, when arranged at the intermediate image plane, to receive and reflect at least a substantial portion of the intermediate light beams 150 towards the second optical sub-assembly 180 so that an axis of a cone 126 of the reflected intermediate light beams at least substantially aligns with the second optical axis 122 of the second optical sub-assembly 180. That is, for example, the angular separation between the axis of the cone 126 of the reflected intermediate light beams and the second optical axis 122 of the second optical sub-assembly 180 may be no greater than about 10 degrees, about 5 degrees, about 3 degrees, about 1 degree, about 0.5 degree, about 0.1 degree, including values and subranges therebetween. The configuration of the blazed mirror 170 that allows for the substantial portion of the intermediate light beams 150 to be reflected to, and received by, the second optical sub-assembly 180 is further illustrated with reference to FIG. 2. In some embodiments, upon receiving the cone 126 of reflected intermediate light beams from the blazed mirror 170, the second optical sub-assembly 180 may produce resultant light beams and direct those resultant light beams towards an image capture device to produce an oblique image 190 of the oblique plane 110 at the image capture device. Examples of an image capture device include a CCD camera, a film, complementary metal oxide semiconductor (CMOS) sensors, and/or any other image capture device configured to receive the resultant light beams and convert the photons of the resultant light beams to create the oblique image 190 of the oblique plane 110.

FIG. 2 shows a schematic diagram illustrating reduction or elimination of signal loss by using a blazed mirror in an OPM system, in accordance with various embodiments. In some embodiments, the blazed mirror 210 may have a reflective front surface with a sawtooth profile spaced apart a spacing 220 which may be a uniform spacing or non-uniform spacing along the blazed mirror 210. In some instances, the blazed mirror 210 may be characterized by the blazing angle 230 of the sawtooth profile of the front surface of the blazed mirror 210, and the blazing angle 230 may correspond to the angle between the axis 214 that is normal to the blazed mirror (e.g., normal to the base or bottom surface of the blazed mirror 210) and the axis 290 that is normal to the blazed front surface of the blazed mirror 210.

In some embodiments, the blazed mirror 210 may be arranged at the intermediate image plane of an OPM system 100 as discussed above with reference to FIG. 1 and may be configured such that the blazed mirror 210 receives and reflects at least a substantial portion of the intermediate light beams 260 towards the second optical sub-assembly 240 so that an axis of a cone 280 of the reflected intermediate light beams at least substantially aligns with the second optical axis of the second optical sub-assembly 240 which in turn aligns with the axis 214 that is normal to the blazed mirror. That is, the blazed mirror 210 that is arranged to overlap and/or positioned to be substantially parallel to the intermediate image plane of an OPM system 100 may have a blazing angle 230 such that incoming intermediate light beams 260 are reflected about the axis 290 that is normal to the blazed front surface of the blazed mirror 210 to be directed to the second optical sub-assembly 180 (e.g., as a cone 280 of reflected intermediate light beams having an axis aligned with the axis 214 that is normal to the blazed mirror). In some instances, such reflection of incoming intermediate light beams 260 may allow for a substantial portion of the incoming intermediate light beams 260 to be redirected or reflected towards the second optical sub-assembly 240 with little signal or beam loss (e.g., and in some cases no loss), which can then be imaged as the oblique image 250 of the oblique plane of a sample at the image capture device. For example, for an OPM system with a first optical sub-assembly and a second optical sub-assembly having the numerical apertures disclosed above (e.g., values and subranges in the range from about 0.01 to about 1.65), the at least substantial portion of the incoming intermediate light beams 260 that is redirected or reflected towards the second optical sub-assembly 240 can be in the range from about 90% to about 100%, from about 95% to about 100%, from about 99% to about 100%, etc., including values and subranges therebetween. For instance, the intensity of the cone 280 of reflected intermediate light beams may be in the range from about 90% to about 100%, from about 95% to about 100%, from about 99% to about 100%, etc., including values and subranges therebetween, of the intensity of the incoming intermediate light beams 260.

In some embodiments, the benefits of using a blazed mirror (e.g., such as blazed mirror 170/210) in an OPM system may be illustrated by comparing the afore-mentioned portion of the incoming intermediate light beams 260 with a portion of the incoming intermediate light beams 260 that would be reflected towards the second optical sub-assembly 240 if the blazed mirror 210 was replaced by a mirror with a flat reflective surface. In such a case, the incoming intermediate light beams 260 may be reflected about the axis 214 normal to the mirror (e.g., in contrast to being reflected about the axis 290 that is normal to the blazed front surface of the blazed mirror 210) to produce the reflected light beams 270. The axis of the cone of the reflected light beams 270, however, may not align with the optical axis of the second optical sub-assembly 240 (e.g., equivalently the axis 214 that is normal to the mirror) and as such at least some of the reflected light beams 270 may not be received by the second optical sub-assembly 240, resulting in the loss of signal or light beams and degraded oblique images when the reflected light beams are imaged as the oblique image 250 of the oblique plane of a sample at the image capture device.

In some embodiments, the blazed mirror 210 is a digital micromirror device. In some embodiments, the blazed mirror 210 may include an array of mirrors tilted, with respect to a base or bottom surface of the blazed mirror 210, at a tilting angle corresponding to a blazing angle 230 of the blazed mirror. That is, reflective front surface with the sawtooth profile may be an array of reflective mirrors spaced apart a spacing 220 and titled at the blazing angle 230 of the blazing mirror 210. In some instances, the tilting angle of the mirrors may be adjustable (e.g., and as such, the blazing angle of the blazed mirror 210 may be adjusted in situ during the operation of the OPM system). In some embodiments, the blazed mirror 210 may be realized through nanofabrication or by using a diamond milling followed by coating the surface with high reflection coating.

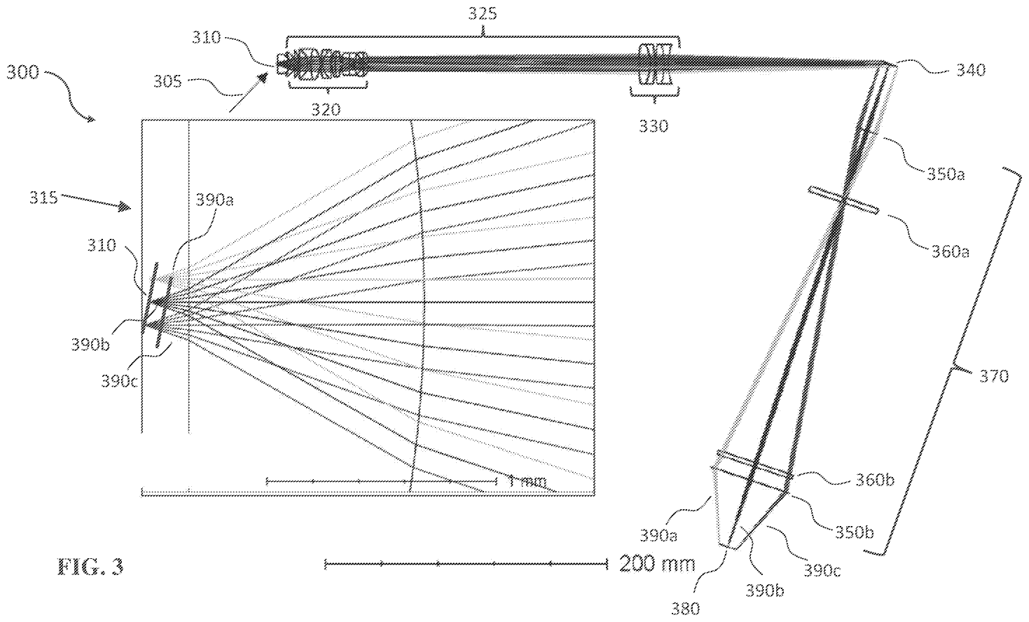

FIG. 3 shows an example computer ray-tracing simulation illustrating oblique plane imaging with an OPM system employing a blazed mirror, in accordance with various embodiments. In some embodiments, the propagation of excited light beams emitted by an oblique plane of a sample, via an OPM system employing a blazed mirror and including a first optical sub-assembly having an objective lens and a first numerical aperture and a second optical sub-assembly having a second numerical aperture, were ray-traced in a computer simulation for a variety of first numerical aperture, second numerical aperture, magnification, blazing angle, etc., values, and the results demonstrate that the blazed mirror allows formation of an oblique image of the oblique plane at an image capture device. For example, FIG. 3 shows a ray-tracing computer simulation of three excitation beams 390a, 390b, 390c emitted by the oblique plane 310 of a sample that propagated through an OPM system 300 to arrive at an image capture device and combine to form an oblique image 380 of the oblique plane 310. As indicated by the arrow 305, feature 315 shows an exploded view of the oblique plane 310 and the emission of three excitation beams 390a, 390b, 390c therefrom. The OPM system 300 includes the first optical sub-assembly 325 including an objective lens 320 and a tube lens 330, the blazed mirror 340, the second optical sub-assembly 370 including lenses 350a, 350b, cylindrical lenses 360a, 360b. In FIG. 3, the objective lens 320 is a 20× objective lens with numerical aperture 0.7, the blazing angle of the blazed mirror 340 is 35 degrees, and the blazed mirror is tilted at an angle of 70 degrees with respect to the optical axis of the first optical sub-assembly 325. Ray tracing the three excitation beams 390a, 390b, 390c along the propagation path along the OPM system 300 illustrates that each beam arrives at the image capture device 380 and combines to form the oblique image 380 of the oblique plane 310.

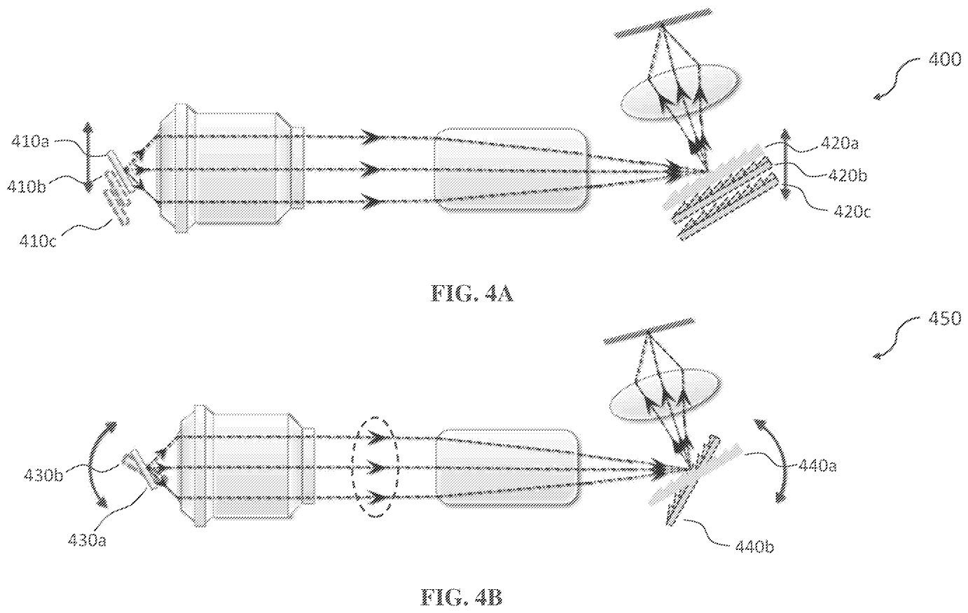

FIGS. 4A-4B show example schematics illustrating imaging of multiple oblique planes of a sample using a OPM systems for generating a three-dimensional (3D) volumetric image of the sample, in accordance with various embodiments. In some embodiments, the OPM system 400 and the OPM system 450 are substantially similar to the OPM system 100 discussed with reference to FIG. 1 and as such will not be described in detail further. FIG. 4A shows an example embodiment of 3D imaging technique where multiple oblique planes 410a, 410b, 410c of a sample are imaged as described throughout the instant disclosure to produce respective oblique images at the image capture device, which may then be combined to generate a 3D volumetric image of the sample. For example, imaging softwares such as but not limited to imageJ, Fiji, Vaa3D, etc., may be used to combine the respective oblique images of oblique planes of the sample to generate the 3D volumetric image of the sample. In some instances, the oblique planes 410a, 410b, 410c of the sample may be laterally displaced with each other. In such cases, the blazed mirror of the OPM system 400 may also be laterally displaced so that the blazed mirrors 420a, 420b, 420c overlap with the intermediate image planes of the OPM system 400 for the respective oblique planes 410a, 410b, 410c of the sample. It is to be noted that FIG. 4A is a non-limiting example illustration and that any number of oblique planes (e.g., 2, 4, 5, 6, 7, 8, 9, 10, etc.) of a sample may be imaged to generate respective images at the image capture device for generating 3D volumetric image of the sample.

In some embodiments, FIG. 4B shows an example embodiment of 3D imaging technique where multiple oblique planes 430a, 430b of a sample that are rotated with respect to each other are imaged using the OPM system 450. For example, the oblique plane 430b is rotated with respect to the oblique plane 430a. In such cases, the blazed mirror of the OPM system 450 may also be rotated with respect to each other so that the blazed mirrors 440a, 440b overlap with the intermediate image planes of the OPM system 450 for the respective oblique planes 430a, 430b of the sample. That is, for instance, the blazed mirror 440b will be rotated with respect to the blazed mirror 440a such that the blazed mirror 440b overlaps with the intermediate image plane of the OPM system 450 for the oblique plane 430b (e.g., the blazed mirror 440a may also overlap with the intermediate image plane of the OPM system 450 for the oblique plane 430a). It is to be noted that FIG. 4B is a non-limiting example illustration and that any number of oblique planes (e.g., 3, 4, 5, 6, 7, 8, 9, 10, etc.) of a sample may be imaged to generate respective images at the image capture device for generating 3D volumetric image of the sample.

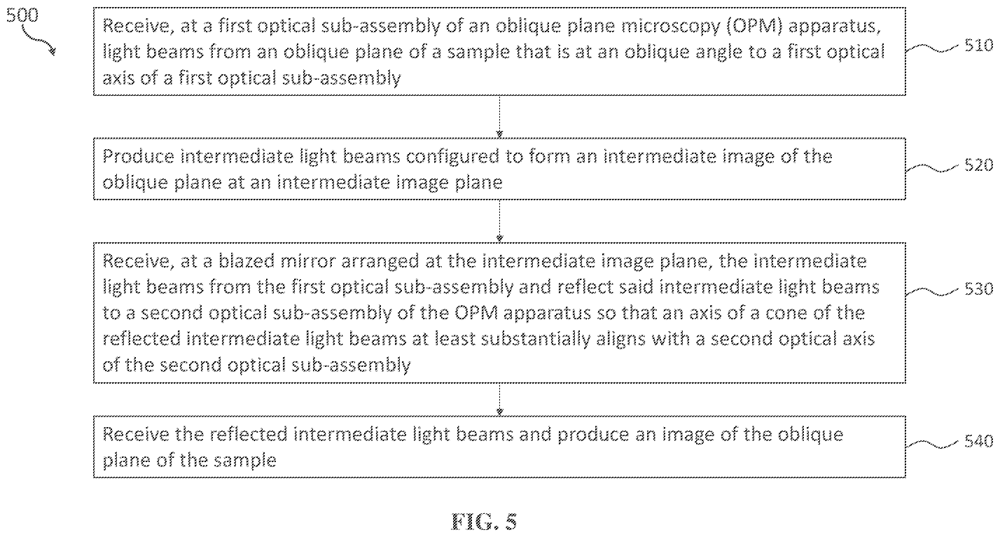

FIG. 5 is a flow chart illustrating an OPM method, in accordance with various embodiments. Method 500 may be performed at least partially by the OPM system, or components thereof, of FIGS. 1-4 (e.g., the OPM systems 100/400). As illustrated, the method 500 includes a number of enumerated steps, but aspects of the method 500 may include additional steps before, after, and in between the enumerated steps. In some aspects, one or more of the enumerated steps may be omitted or performed in a different order.

At step 510, in some embodiments, the method comprises receiving, at a first optical sub-assembly of an OPM system having a first numerical aperture and an objective lens, light beams from an oblique plane of a sample that is at an oblique angle to a first optical axis of the first optical sub-assembly.

At step 520, in some embodiments, the method comprises producing, by the first optical sub-assembly, intermediate light beams configured to form an intermediate image of the oblique plane at an intermediate image plane.

At step 530, in some embodiments, the method comprises receiving, at a blazed mirror arranged at the intermediate image plane, the intermediate light beams from the first optical sub-assembly and reflect said intermediate light beams to a second optical sub-assembly of the OPM system so that an axis of a cone of the reflected intermediate light beams at least substantially aligns with a second optical axis of the second optical sub-assembly. In some instances, the second optical sub-assembly may have a second numerical aperture. In some instances, an angle between the first optical axis and the second optical axis at the intermediate image plane may relate to the oblique angle.

At step 540, in some embodiments, the method comprises receiving the reflected intermediate light beams and producing an image of the oblique plane of the sample.

In some embodiments, the first numerical aperture and/or the second numerical aperture range from about 0.01 to about 1.65, from about 0.1 to about 1.25, from about 0.25 to about 1, from about 0.4 to about 0.75, etc., including values and subranges therebetween. In such instances, an intensity of the reflected intermediate light beams can be no less than about 75%, about 80%, about 90%, about 99%, about 99.9%, about 100%, etc., including values and subranges therebetween, of an intensity of the light beams from an oblique plane of the sample. In some embodiments, the objective lens may operate without an immersion fluid. In such instances, a working distance of the objective lens ranges from about 0.03 mm to about 50 mm, from about 0.1 mm to about 25 mm, from about 0.5 mm to about 10 mm, from about 1 mm to about 5 mm, etc., including values and subranges therebetween.

In some embodiments, the blazed mirror includes an array of mirrors tilted, with respect to a base of the blazed mirror, at a tilting angle corresponding to a blazing angle of the blazed mirror. In some instances, the tilting angle of the array of mirrors may be adjustable. In some embodiments, the blazed mirror can be a digital micromirror device. In some embodiments, the blazed mirror can be arranged at the intermediate image plane at least substantially parallel to the intermediate image plane.

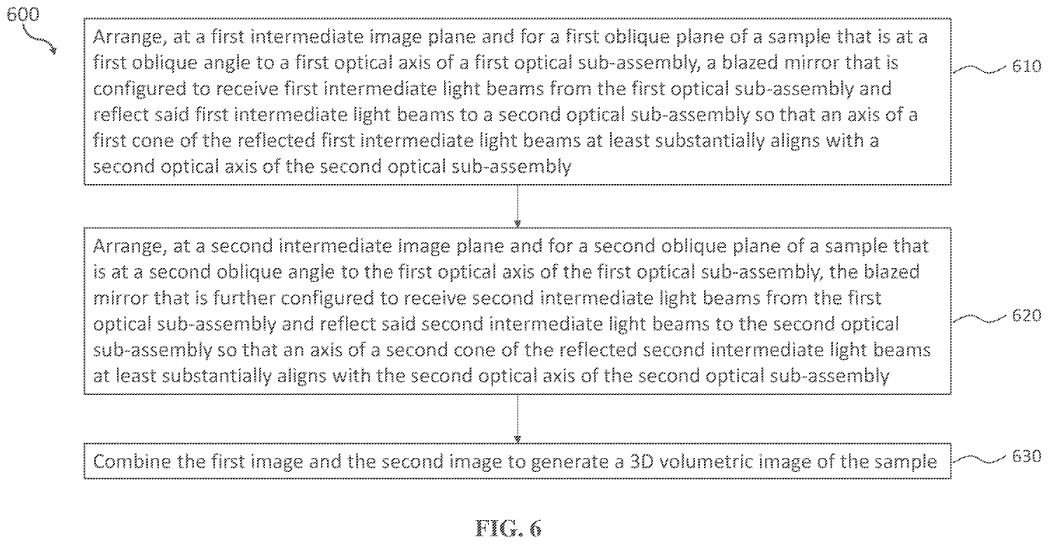

FIG. 6 is a flow chart illustrating a method for generating a 3D volumetric image of a sample, in accordance with various embodiments. Method 600 may be performed at least partially by the OPM system, or components thereof, of FIGS. 1-4 (e.g., the OPM systems 100/400). As illustrated, the method 600 includes a number of enumerated steps, but aspects of the method 600 may include additional steps before, after, and in between the enumerated steps. In some aspects, one or more of the enumerated steps may be omitted or performed in a different order.

At step 610, in some embodiments, the method comprises arranging, at a first intermediate image plane and for a first oblique plane of a sample that is at a first oblique angle to a first optical axis of a first optical sub-assembly, a blazed mirror that is configured to receive first intermediate light beams from the first optical sub-assembly and reflect said first intermediate light beams to a second optical sub-assembly so that an axis of a first cone of the reflected first intermediate light beams at least substantially aligns with a second optical axis of the second optical sub-assembly. In some instances, the first optical sub-assembly may be configured to receive first light beams from the first oblique plane and provide the first intermediate light beams to the blazed mirror. In some instances, the second optical sub-assembly may be configured to receive the reflected first intermediate light beams and produce a first image of the first oblique plane. In some instances, a first angle between the first optical axis and the second optical axis at the first intermediate image plane may be related to the first oblique angle.

At step 620, in some embodiments, the method comprises arranging, at a second intermediate image plane and for a second oblique plane of a sample that is at a second oblique angle to the first optical axis of the first optical sub-assembly, the blazed mirror that is further configured to receive second intermediate light beams from the first optical sub-assembly and reflect said second intermediate light beams to the second optical sub-assembly so that an axis of a second cone of the reflected second intermediate light beams at least substantially aligns with the second optical axis of the second optical sub-assembly. In some instances, the first optical sub-assembly may be configured to receive second light beams from the second oblique plane and provide the second intermediate light beams to the blazed mirror. In some instances, the second optical sub-assembly may be configured to receive the reflected second intermediate light beams and produce a second image of the second oblique plane. In some instances, a second angle between the first optical axis and the second optical axis at the second intermediate image plane may be related to the second oblique angle.

At step 630, in some embodiments, the method comprises combining the first image and the second image to generate a 3D volumetric image of the sample.

In some embodiments, the blazed mirror may be arranged at the first intermediate image plane at least substantially parallel to the first intermediate image plane; and the blazed mirror may be arranged at the second intermediate image plane at least substantially parallel to the second intermediate image plane.

In some embodiments, the second intermediate image plane is shifted laterally compared to the first intermediate image plane. In some embodiments, the second intermediate image plane is rotated with respect to the first intermediate image plane.

In some embodiments, the blazed mirror includes an array of mirrors tilted, with respect to a base of the blazed mirror, at a tilting angle corresponding to a blazing angle of the blazed mirror. In some instances, the tilting angle of the array of mirrors is adjustable. In some embodiments, the blazed mirror is a digital micromirror device.

In some embodiments, the sample can be a deoxyribonucleic acid (DNA) sample. In some embodiments, the sample can be a sample of live cells.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” As used herein, the term “about” used with respect to numerical values or parameters or characteristics that can be expressed as numerical values means within ten percent of the numerical values. For example, “about 50” means a value in the range from 45 to 55, inclusive.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described components and systems can generally be integrated together in a single entity. Other variations are within the scope of the following claims.

### RECITATION OF EMBODIMENTS

Embodiment 1. An oblique plane microscopy (OPM) system, comprising: a first optical sub-assembly having a first numerical aperture and an objective lens, the first optical sub-assembly configured to: receive light beams from an oblique plane of a sample that is at an oblique angle to a first optical axis of the first optical sub-assembly; and produce intermediate light beams configured to form an intermediate image of the oblique plane at an intermediate image plane; a blazed mirror arranged at the intermediate image plane and configured to receive the intermediate light beams from the first optical sub-assembly and reflect said intermediate light beams to a second optical sub-assembly so that an axis of a cone of the reflected intermediate light beams at least substantially aligns with a second optical axis of the second optical sub-assembly, an angle between the first optical axis and the second optical axis at the intermediate image plane relating to the oblique angle; and the second optical sub-assembly having a second numerical aperture and configured to receive the reflected intermediate light beams and produce an image of the oblique plane of the sample.

Embodiment 2. The OPM system of embodiment 1, wherein the first numerical aperture and/or the second numerical aperture range from about 0.01 to about 1.65.

Embodiment 3. The OPM system of embodiment 1 or 2, wherein an intensity of the reflected intermediate light beams is no less than about 90% of an intensity of the light beams from an oblique plane of the sample.

Embodiment 4. The OPM system of any of embodiments 1-3, wherein the objective lens operates without an immersion fluid.

Embodiment 5. The OPM system of any of embodiments 1-4, wherein a working distance of the objective lens ranges from about 0.03 mm to about 50 mm.

Embodiment 6. The OPM system of any of embodiments 1-5, wherein the blazed mirror includes an array of mirrors tilted, with respect to a base of the blazed mirror, at a tilting angle corresponding to a blazing angle of the blazed mirror.

Embodiment 7. The OPM system of any of embodiments 1-6, wherein the tilting angle of the array of mirrors is adjustable.

Embodiment 8. The OPM system of any of embodiments 1-7, wherein the blazed mirror is a digital micromirror device.

Embodiment 9. The OPM system of any of embodiments 1-8, wherein the blazed mirror is arranged at the intermediate image plane at least substantially parallel to the intermediate image plane.

Embodiment 10. An oblique plane microscopy (OPM) method, comprising: receiving, at a first optical sub-assembly of an OPM system having a first numerical aperture and an objective lens, light beams from an oblique plane of a sample that is at an oblique angle to a first optical axis of the first optical sub-assembly; producing, by the first optical sub-assembly, intermediate light beams configured to form an intermediate image of the oblique plane at an intermediate image plane; receiving, at a blazed mirror arranged at the intermediate image plane, the intermediate light beams from the first optical sub-assembly and reflect said intermediate light beams to a second optical sub-assembly of the OPM system so that an axis of a cone of the reflected intermediate light beams at least substantially aligns with a second optical axis of the second optical sub-assembly, the second optical sub-assembly having a second numerical aperture; and receiving the reflected intermediate light beams and producing an image of the oblique plane of the sample, an angle between the first optical axis and the second optical axis at the intermediate image plane relating to the oblique angle.

Embodiment 11. The OPM method of embodiment 10, wherein the first numerical aperture and/or the second numerical aperture range from about 0.01 to about 1.65.

Embodiment 12. The OPM method of embodiment 10 or 11, wherein an intensity of the reflected intermediate light beams is no less than about 90% of an intensity of the light beams from an oblique plane of the sample.

Embodiment 13. The OPM method of any of embodiments 10-12, wherein the objective lens operates without an immersion fluid.

Embodiment 14. The OPM method of any of embodiments 10-13, wherein a working distance of the objective lens ranges from about 0.03 mm to about 50 mm.

Embodiment 15. The OPM method of any of embodiments 10-14, wherein the blazed mirror includes an array of mirrors tilted, with respect to a base of the blazed mirror, at a tilting angle corresponding to a blazing angle of the blazed mirror.

Embodiment 16. The OPM method of any of embodiments 10-15, wherein the tilting angle of the array of mirrors is adjustable.

Embodiment 17. The OPM method of any of embodiments 10-16, wherein the blazed mirror is a digital micromirror device.

Embodiment 18. The OPM method of any of embodiments 10-17, wherein the blazed mirror is arranged at the intermediate image plane at least substantially parallel to the intermediate image plane.

Embodiment 19. A three-dimensional (3D) imaging method, comprising: arranging, at a first intermediate image plane and for a first oblique plane of a sample that is at a first oblique angle to a first optical axis of a first optical sub-assembly, a blazed mirror that is configured to receive first intermediate light beams from the first optical sub-assembly and reflect said first intermediate light beams to a second optical sub-assembly so that an axis of a first cone of the reflected first intermediate light beams at least substantially aligns with a second optical axis of the second optical sub-assembly, the first optical sub-assembly configured to receive first light beams from the first oblique plane and provide the first intermediate light beams to the blazed mirror; the second optical sub-assembly configured to receive the reflected first intermediate light beams and produce a first image of the first oblique plane; and a first angle between the first optical axis and the second optical axis at the first intermediate image plane relating to the first oblique angle; arranging, at a second intermediate image plane and for a second oblique plane of a sample that is at a second oblique angle to the first optical axis of the first optical sub-assembly, the blazed mirror that is further configured to receive second intermediate light beams from the first optical sub-assembly and reflect said second intermediate light beams to the second optical sub-assembly so that an axis of a second cone of the reflected second intermediate light beams at least substantially aligns with the second optical axis of the second optical sub-assembly, the first optical sub-assembly configured to receive second light beams from the second oblique plane and provide the second intermediate light beams to the blazed mirror; the second optical sub-assembly configured to receive the reflected second intermediate light beams and produce a second image of the second oblique plane; a second angle between the first optical axis and the second optical axis at the second intermediate image plane may be related to the second oblique angle; and combining the first image and the second image to generate a 3D volumetric image of the sample.

Embodiment 20. The 3D imaging method of embodiment 19, wherein: the blazed mirror is arranged at the first intermediate image plane at least substantially parallel to the first intermediate image plane; and the blazed mirror is arranged at the second intermediate image plane at least substantially parallel to the second intermediate image plane.

Embodiment 21. The 3D imaging method of embodiment 19 or 20, wherein the second intermediate image plane is shifted laterally compared to the first intermediate image plane.

Embodiment 22. The 3D imaging method of any of embodiments 19-21, wherein the second intermediate image plane is rotated with respect to the first intermediate image plane.

Embodiment 23. The 3D imaging method of any of embodiments 19-22, wherein the blazed mirror includes an array of mirrors tilted, with respect to a base of the blazed mirror, at a tilting angle corresponding to a blazing angle of the blazed mirror.

Embodiment 24. The 3D imaging method of any of embodiments 19-23, wherein the tilting angle of the array of mirrors is adjustable.

Embodiment 25. The 3D imaging method of any of embodiments 19-24, wherein the blazed mirror is a digital micromirror device.

Embodiment 26. The 3D imaging method of any of embodiments 19-25, wherein the sample is a deoxyribonucleic acid (DNA) sample or a sample of live cells.

What is claimed is:

1. An oblique plane microscopy (OPM) system, comprising:
a first optical sub-assembly having a first numerical aperture and an objective lens, the first optical sub-assembly configured to:
receive light beams from an oblique plane of a sample that is at an oblique angle to a first optical axis of the first optical sub-assembly; and
produce intermediate light beams configured to form an intermediate image of the oblique plane at an intermediate image plane;
a blazed mirror arranged at the intermediate image plane and configured to receive the intermediate light beams from the first optical sub-assembly and reflect said intermediate light beams to a second optical sub-assembly so that an axis of a cone of the reflected intermediate light beams at least substantially aligns with a second optical axis of the second optical sub-assembly,
an angle between the first optical axis and the second optical axis at the intermediate image plane relating to the oblique angle; and
the second optical sub-assembly having a second numerical aperture and configured to receive the reflected intermediate light beams and produce an image of the oblique plane of the sample.

2. The OPM system of claim 1, wherein the first numerical aperture and/or the second numerical aperture range from about 0.01 to about 1.65.

3. The OPM system of claim 2, wherein an intensity of the reflected intermediate light beams is no less than about 90% of an intensity of the light beams from an oblique plane of the sample.

4. The OPM system of claim 1, wherein the objective lens operates without an immersion fluid.

5. The OPM system of claim 4, wherein a working distance of the objective lens ranges from about 0.03 mm to about 50 mm.

6. The OPM system of claim 1, wherein one or both of:
the blazed mirror includes an array of mirrors tilted, with respect to a base of the blazed mirror, at a tilting angle that is adjustable and corresponds to a blazing angle of the blazed mirror; and
the blazed mirror is a digital micromirror device.

7. The OPM system of claim 1, wherein the blazed mirror is arranged at the intermediate image plane at least substantially parallel to the intermediate image plane.

8. An oblique plane microscopy (OPM) method, comprising:
receiving, at a first optical sub-assembly of an OPM system having a first numerical aperture and an objective lens, light beams from an oblique plane of a sample that is at an oblique angle to a first optical axis of the first optical sub-assembly;
producing, by the first optical sub-assembly, intermediate light beams configured to form an intermediate image of the oblique plane at an intermediate image plane;
receiving, at a blazed mirror arranged at the intermediate image plane, the intermediate light beams from the first optical sub-assembly and reflect said intermediate light beams to a second optical sub-assembly of the OPM system so that an axis of a cone of the reflected intermediate light beams at least substantially aligns with a second optical axis of the second optical sub-assembly, the second optical sub-assembly having a second numerical aperture; and
receiving the reflected intermediate light beams and producing an image of the oblique plane of the sample,
an angle between the first optical axis and the second optical axis at the intermediate image plane relating to the oblique angle.

9. The OPM method of claim 8, wherein the first numerical aperture and/or the second numerical aperture range from about 0.01 to about 1.65.

10. The OPM method of claim 9, wherein an intensity of the reflected intermediate light beams is no less than about 90% of an intensity of the light beams from an oblique plane of the sample.

11. The OPM method of claim 8, wherein the objective lens operates without an immersion fluid.

12. The OPM method of claim 11, wherein a working distance of the objective lens ranges from about 0.03 mm to about 50 mm.

13. The OPM method of claim 8, wherein one or both of:
the blazed mirror includes an array of mirrors tilted, with respect to a base of the blazed mirror, at a tilting angle that is adjustable and corresponds to a blazing angle of the blazed mirror; and
the blazed mirror is a digital micromirror device.

14. The OPM method of claim 8, wherein the blazed mirror is arranged at the intermediate image plane at least substantially parallel to the intermediate image plane.

15. A three-dimensional (3D) imaging method, comprising:
arranging, at a first intermediate image plane and for a first oblique plane of a sample that is at a first oblique angle to a first optical axis of a first optical sub-assembly, a blazed mirror that is configured to receive first intermediate light beams from the first optical sub-assembly and reflect said first intermediate light beams to a second optical sub-assembly so that an axis of a first cone of the reflected first intermediate light beams at least substantially aligns with a second optical axis of the second optical sub-assembly,
the first optical sub-assembly configured to receive first light beams from the first oblique plane and provide the first intermediate light beams to the blazed mirror;
the second optical sub-assembly configured to receive the reflected first intermediate light beams and produce a first image of the first oblique plane; and
a first angle between the first optical axis and the second optical axis at the first intermediate image plane relating to the first oblique angle;
arranging, at a second intermediate image plane and for a second oblique plane of a sample that is at a second oblique angle to the first optical axis of the first optical sub-assembly, the blazed mirror that is further configured to receive second intermediate light beams from the first optical sub-assembly and reflect said second intermediate light beams to the second optical sub-assembly so that an axis of a second cone of the reflected second intermediate light beams at least substantially aligns with the second optical axis of the second optical sub-assembly,
the first optical sub-assembly configured to receive second light beams from the second oblique plane and provide the second intermediate light beams to the blazed mirror;
the second optical sub-assembly configured to receive the reflected second intermediate light beams and produce a second image of the second oblique plane;
a second angle between the first optical axis and the second optical axis at the second intermediate image plane relating to the second oblique angle; and
combining the first image and the second image to generate a 3D volumetric image of the sample.

16. The 3D imaging method of claim 15, wherein:
the blazed mirror is arranged at the first intermediate image plane at least substantially parallel to the first intermediate image plane; and
the blazed mirror is arranged at the second intermediate image plane at least substantially parallel to the second intermediate image plane.

17. The 3D imaging method of claim 16, wherein the second intermediate image plane is shifted laterally compared to the first intermediate image plane.

18. The 3D imaging method of claim 16, wherein the second intermediate image plane is rotated with respect to the first intermediate image plane.

19. The 3D imaging method of claim 15, wherein one or both of:
the blazed mirror includes an array of mirrors tilted, with respect to a base of the blazed mirror, at a tilting angle that is adjustable and corresponds to a blazing angle of the blazed mirror; and
the blazed mirror is a digital micromirror device.

20. The 3D imaging method of claim 15, wherein the sample is a deoxyribonucleic acid (DNA) sample or a sample of live cells.
